(19) United States
(12) Patent Application Publication
(10) Pub. No.: US 2007/0262069 A1
(43) Pub. Date: Nov. 15, 2007

(54) Heating Device for Electronic Components in Military Vehicles

(76) Inventor: Stefan Foehst, Kassel (DE)

Correspondence Address: ROBERT W. BECKER & ASSOCIATES;Suite B, 707 State Highway 333, Tijeras, NM, 87059-7507, US

(21) Appl. No.: 11/746,741

(22) Filed: May 10, 2007

(30) Foreign Application Priority Data
May 10, 2006 (DE) 20 2006 007 436.8

(51) Int. Cl. A21B 1/22

(52) U.S. Cl. 219/400

(57) ABSTRACT

A heating device for electronic components in a military vehicle, comprising a flat housing having an air inlet opening in at least one narrow side wall thereof and an air outlet opening in an upper side thereof. A metallic cooling element is disposed in the housing and includes a plate having ribs or pins disposed on a surface thereof that faces the upper side of the housing. A surface of the plate facing away from the upper side of the housing is in contact with at least one heating element. An axial fan is disposed on the upper side of the housing in or upstream of the air outlet opening.

The instant application should be granted the priority date of 10 May 2006 the filing date of the corresponding German patent application DE 20 2006 007 436.8.

### BACKGROUND OF THE INVENTION

The present invention relates to a heating device for electronic components in military vehicles, especially tanks.

Regulations exist according to which military vehicles, especially tanks, must be designed in such a way that they can function to a temperature of −46° C. Since electronic devices installed in such vehicles are generally designed in such a way that they should not be cooled to a temperature below −35° C., it is necessary to provide possibilities for heating electronic components within a tank in such a way that they do not fall below the temperature of −35° C.

It is therefore an object of the present invention to provide a heating device for electronic components in military vehicles, especially tanks, that have a straightforward construction, require little space, and function reliably, and by means of which the possibly required heating can be carried out. Since generally very little installation space is available in military vehicles, especially tanks, it is necessary to configure the heating device in a simple and space-saving manner.

### BRIEF DESCRIPTION OF THE DRAWING

This object, and other objects and advantages of the present invention, will appear more clearly from the following specification in conjunction with the accompanying schematic drawing, in which:

FIG. 1 is a view from below of one exemplary heating device;

FIG. 2 is a view onto the shorter narrow side of the heating device of FIG. 1;

FIG. 3 is a view onto the longer narrow side of the heating device of FIG. 1; and

FIG. 4 is a view from above of the heating device of FIGS. 1 to 3.

### SUMMARY OF THE INVENTION

The object of the present application is realized by a heating device that is characterized by a flat housing having an air inlet opening in at least one of the narrow side walls thereof and an air outlet opening at an upper side thereof, whereby disposed in the housing is a metallic cooling element that includes a plate having ribs or pins disposed on a surface thereof that faces the upper side of the housing, whereas the surface of the plate facing away from the upper side of the housing is in contact with at least one heating element, and an axial fan is disposed on the upper side of the housing in or upstream of the air outlet opening.

It is particularly advantageous if the housing is embodied as a U-shaped profiled element that is open at the underside and at two narrow sides. The axial fan is disposed on the upper side of the profiled element, while an electrical connection plug is disposed on one of the legs of the profiled element. At least one resistance heating foil is disposed on that surface of the plate of the cooling element that faces away from the upper side of the housing. Furthermore, at least one temperature-controlled switch element can be disposed on that surface of the plate of the cooling element that faces away from the upper side of the housing.

The basic concept of the present application is, with a straightforward construction, to heat a pinned cooling element, such as is known from the processor industry, and to withdraw or discharge the heated air by means of an axial fan having a simple construction. It has been shown that the inventive heating device can be constructed in a very straightforward, compact and in particular very flat manner, and enables a reliable heating.

Further specific features of the present invention will be described in detail subsequently.

### DESCRIPTION OF SPECIFIC EMBODIMENTS

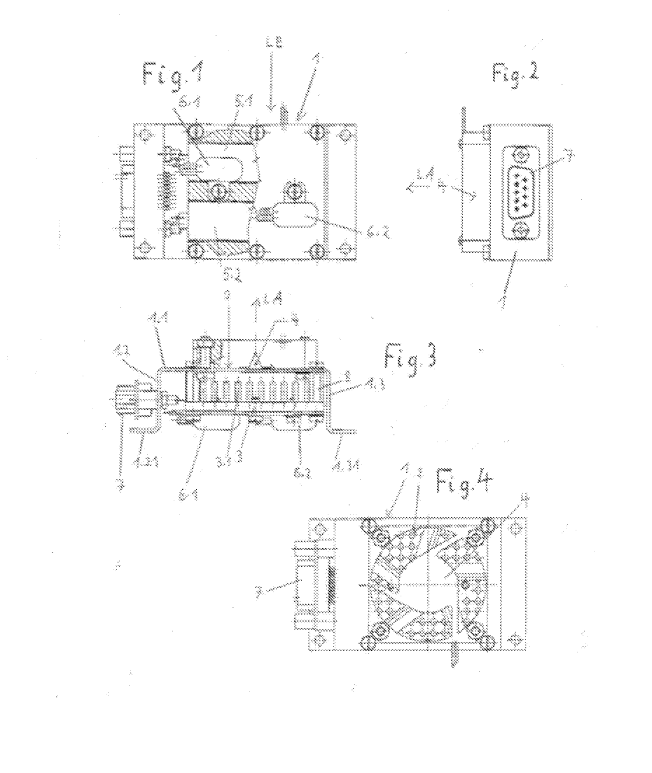

Referring now to the drawing in detail, the heating device illustrated in FIGS. 1 to 4 is provided with a flat housing 1 having an essentially rectangular configuration and embodied as a U-shaped profiled element that is open on the underside as well as at the two longer narrow sides. The profiled housing element has an upper side 1.1, corresponding to the base of the U, as well as two legs 1.2 and 1.3 at the shorter narrow sides. At their lower ends, the legs are provided with flange-like bent portions 1.21 and 1.31 via which the housing can be secured to a support in a non-illustrated vehicle via screw connections.

The housing 1 has an air outlet opening 2 on the upper side 1.1 (see FIG. 4).

Disposed in the housing 1 is a metallic cooling element having a plate 3 on the surface of which that faces the upper side of the housing are disposed ribs or pins 3.1 to enlarge the surface. The cooling element is suspended in the housing via screw connections 8.

Disposed on the underside of the plate 3 of the cooling element are resistance heating foils 5.1 and 5.2 via which the plate 3 can be heated. An axial fan 4 is disposed in the air outlet opening 2 at the upper side of the housing 1. The axial fan 4 draws the air out of the housing 1 that flows in the direction of the arrow LE through the open side walls of the housing, and is then discharged outwardly, in a heated state, in the direction of the arrow LA.

Two temperature-controlled switch elements 6.1 and 6.2 are furthermore disposed on the underside of the plate 3; switching on and off of the device is controlled via these switch elements. An electrical connection plug 7 is secured to one of the legs of the housing 1, and in the illustrated embodiment to the leg 1.2. The resistance heating foils 5.1 and 5.2, the switch elements 6.1 and 6.2, and the axial fan 4 are connected to the connection plug 7, via which they are connected to non-illustrated means for the supply of electrical energy and for the input and output of signals.

The specification incorporates by reference the disclosure of German priority document 20 2006 007 436.8 filed May 10, 2006.

The present invention is, of course, in no way restricted to the specific disclosure of the specification and drawing, but also encompasses any modifications within the scope of the appended claims.

What I claim is:

1. A heating device for electronic components in a military vehicle, comprising:
a flat housing (1) having an air inlet opening in at least one narrow side wall thereof and an air outlet opening (2) at an upper side (1.1) thereof;
a metallic cooling element disposed in said housing (1), wherein said cooling element includes a plate (3) having ribs or pins (3.1) disposed on a surface thereof that faces said upper side (1.1) of said housing (1);
at least one heating element (5.1, 5.2), wherein a surface of said plate (3) that faces away from said upper side (1.1) of said housing (1) is in contact with said at least one heating element (5.1, 5.2); and
an axial fan (4) disposed on said upper side (1.1) of said housing (1) in or upstream of said air outlet opening (2).

2. A heating device according to claim 1, wherein said housing (1) is in the form of a U-shaped profiled element that is open at an underside thereof and at two narrow sides thereof, wherein said axial fan (4) is disposed on said upper side (1.1) of said profiled housing element, and wherein an electrical connection plug (7) is disposed on a leg (1.2) of said profiled element.

3. A heating device according to claim 2, wherein at least one resistance heating foil (5.1, 5.2), as said at least one heating element, is disposed on said surface of said plate (3) that faces away from said upper side (1.1) of said profiled housing element.

4. A heating device according to claim 2, wherein at least one temperature-controlled switch element (6.1, 6.2) is disposed on that surface of said plate (3) that faces away from said upper side (1.1) of said profiled housing elmement.
